(19) United States
(12) Patent Application Publication
(10) Pub. No.: US 2011/0278971 A1
(43) Pub. Date: Nov. 17, 2011

(54) ROTARY MACHINE

(75) Inventor: Hironori MATSUMOTO, Hitachi (JP)

(73) Assignee: HITACHI, LTD.

(21) Appl. No.: 13/105,034

(22) Filed: May 11, 2011

(30) Foreign Application Priority Data
May 14, 2010 (JP) 2010-111615

(51) Int. Cl. H02K 9/22

(52) U.S. Cl. 310/64; 310/52

(57) ABSTRACT

A rotary machine including: a stator in the rotary machine; and a stator coil provided in the stator, a part or all of the stator and the stator coil being molded with resin to insulate the stator coil, wherein one or more materials having high thermal conductivity are provided on the inside or the outside of the resin and coupled to a heat radiating section on the outside of the resin by the materials having high thermal conductivity. Consequently, it is possible to realize a rotary machine that is small and light, has high heat radiation properties, and stably operates for a long time.

### BACKGROUND OF THE INVENTION

The present application relates to a rotary machine molded with resin.

As shown in FIG. 1, a rotary machine has a structure in which a rotor 1 and a stator 2 that generate mechanical rotation force from electric energy, a rotating shaft 3 that is connected to the rotor 1 and transmits the generated rotation force to the outside, and a bearing 4 that supports the rotating shaft 3 are provided and housed on the inside of a housing including a frame 5 and an end bracket 6. As a result, the rotary machine prevents intrusion of dirt and dust from the outdoor air and has a soundproof effect. Further, since an electric current flows to a stator coil 7 during driving, space insulation 8 is provided in order to secure insulation between the stator coil 7 and the frame 5 or the end bracket 6.

A reduction in size and weight of the rotary machine has been demanded from the viewpoint of energy saving and resource saving in these days. The reduction in size and weight of the rotary machine has been realized by structure optimization through highly-accurate three-dimensional electromagnetic field analysis. According to many reports, the advance of the material development technique improves rotary machine performance and significantly contributes to the reduction in size and weight. Above all, engineering plastic used in industrial applications since around 1970 has been attracting attention as a new material replacing the metal material. As a result, application of the engineering plastic to the rotary machine has also been examined. A rotary machine in which resin is applied to a part of components has been developed. As a result, the resin plays a role of insulation reinforcement for a stator coil and as a structure member, whereby the reduction in size and weight has been attained.

However, in general, heat radiation performance of the resin is as low as about one several tenths to one several hundredths of that of metal. Therefore, the application of the resin is only partial or is limited to a rotary machine of a small class having relatively small heat generation. Currently, the resin is manufactured into products such as a servo motor. However, it is difficult to apply the resin to a rotary machine requiring continuous operation such as a general-purpose motor. Therefore, for the application of the resin to rotary machines of medium to large classes including the general-purpose motor, it is essential to adopt a new heat radiation structure for solving deterioration in heat radiation properties.

Under such circumstances, in JP-A-2007-295733, an inner frame around a stator is molded with first resin and the vicinity of the inner frame is molded with second resin with thermal conductivity improved by adding a thermally conductive filler in order to improve heat radiation properties. In JP-A-2003-70208, a stator and an end bracket are coupled by a thermally conductive bar material to thermally transport generated heat located further on the center side than the resin to a rotary machine end.

### BRIEF SUMMARY OF THE INVENTION

JP-A-2007-295733 in the above explanation attempts to solve the problems by loading a filler having high thermal conductivity into the second resin. However, even resin having high thermal conductivity has an upper limit of about 10 W/mK. In a result of heat radiation simulation by the present inventors, components of the rotary machine are not durable thermally and operation for a long time is still impossible.

In JP-A-2003-70208, the stator serving as a heat generating section and the end bracket are coupled by a thermally conductive member and a heat radiation path from the stator to the end bracket is provided. However, since heat is also transported from a rotor to the end bracket via a bearing, the generated heat is not efficiently transported to the outside.

Therefore, in view of the above problems, the present invention provides a rotary machine with high heat radiation properties including a sufficient heat radiation structure for suppressing an excessive temperature rise.

In order to solve the problems, according to the present invention, there is provided, for example, a rotary machine including: a stator in the rotary machine; and a stator coil provided in the stator, a part or all of the stator and the stator coil being molded with resin to insulate the stator coil, wherein one or more materials having high thermal conductivity (e.g., a carbon graphite sheet) are provided on the inside or the outside of the resin and coupled to a heat radiating section on the outside of the resin by the materials having high thermal conductivity to lead generated heat in the rotary machine to the heat radiating section.

According to the means explained above, it is possible to realize a rotary machine that is small and light, has high heat radiation properties, and stably operates for a long time.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a rotary machine sectional view for explaining a rotary machine in the past (a half model);

FIG. 2 is a rotary machine sectional view for explaining an embodiment of the present invention (a half model);

FIG. 3 is a rotary machine axial direction end sectional view for explaining the embodiment of the present invention;

FIG. 4 is a rotary machine sectional view for explaining another embodiment of the present invention (a half model);

FIG. 5 is a rotary machine sectional view for explaining still another embodiment of the present invention (a half model);

FIG. 6 is a stator core external view for explaining a fin structure in the embodiment of the present invention;

FIG. 7 is a rotary machine sectional view for explaining still another embodiment of the present invention (a half model);

FIG. 8 is a diagram for explaining resin added with a filler having a particle diameter equal to or smaller than 100 nm in the still other embodiment of the present invention;

FIG. 9 is a diagram for explaining resin in the past;

FIG. 10 is a rotary machine external view for explaining an example of the present invention of trial manufacturing;

FIG. 11 is a rotary machine external view for explaining another example of the present invention of trial manufacturing;

FIG. 12 is a rotary machine sectional view for explaining an example in the past for comparison (a half model);

FIG. 13 is a rotary machine sectional view for explaining a comparative example in which the embodiment of the present invention of trial manufacturing is partially incorporated in order to verify an effect of the embodiment of the present invention (a half model);

FIG. 14 is a rotary machine sectional view for explaining a comparative example in which the other embodiment of the present invention of trial manufacturing is partially incorporated in order to verify the effect of the embodiment of the present invention (a half model); and

FIG. 15 is a graph of temperature rise tests for stator core coils by trial manufacturing 1, trial manufacturing 2, trial manufacturing 3, and trial manufacturing 4 according to the embodiment of the present invention.

### DETAILED DESCRIPTION OF THE INVENTION

Embodiments are explained below with reference to the accompanying drawings. It should be noted that the drawings are schematic and a relation between thickness and plane dimensions, a ratio of layer thicknesses, and the like are different from actual ones. Therefore, specific thicknesses and dimensions should be determined taking into account the following explanation. It goes without saying that, among the drawings, portions having different relations and ratios of dimensions are included.

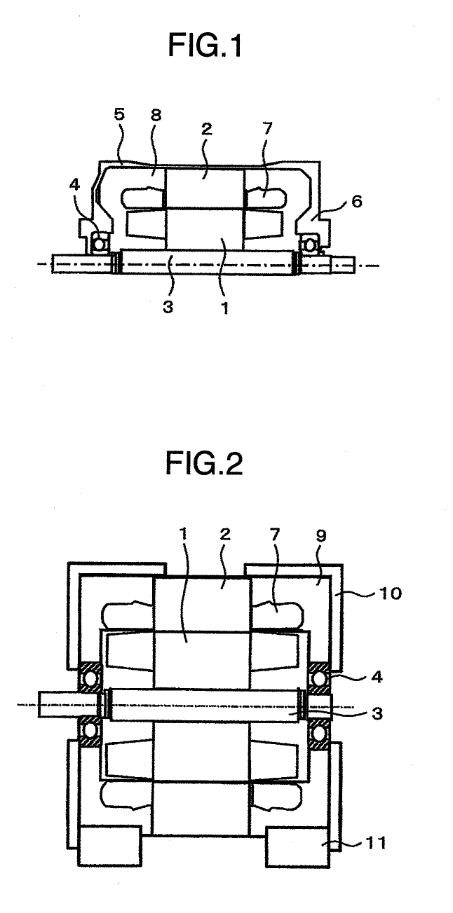

FIG. 2 is a rotary machine sectional view according to an embodiment of the present invention. This embodiment has a structure in which, in FIG. 1 of the embodiment in the past, the frame 5 and the end bracket 6 are removed, the vicinity of the stator coil 7 is molded with the resin 9, and the end bracket 6 is molded with resin 9.

In the rotary machine in the past, as shown in FIG. 1, the stator coil 7, the frame 5, and the end bracket 6 are insulated by the space insulation 8. As a result, according to this embodiment, since the stator coil 7 is molded with the resin 9, it is possible to reduce the space insulation 8 and reduce the size of the rotary machine. Further, in this embodiment, the resin 9 around the end bracket 6 and the stator coil 7 is collectively molded. As a result, the number of components is reduced. This contributes to a reduction in weight. Since a contact interface of the resin 9 is eliminated, contact thermal resistance is reduced. This is thermally advantageous.

Further, in the embodiment shown in FIG. 2, since a coefficient of thermal expansion of resin is large compared with that of metal, a crack of the resin 9 tends to occur because of a thermal expansion difference between the resin and a metal material used in the rotary machine. Therefore, it is desirable to add a large amount of filler such as silica or alumina to the resin 9. As a result, it is possible to reduce the coefficient of thermal expansion of the resin 9 to a degree same as that of metal and thermal stress is reduced. Therefore, it is possible to suppress occurrence of the crack of the resin 9.

In the embodiment, as shown in FIG. 2, a material having high thermal conductivity 10 is provided in contact with the surface of the resin 9. Further, the material having high thermal conductivity 10 is provided also in contact with a part of the stator 2 and a part of the bearing 4. As a result, heat is transmitted from the portion of the resin 9 to the material having high thermal conductivity 10 and, moreover, since the material having high thermal conductivity 10 is directly set in contact with the stator 2 serving as the heat generating section and the bearing 4, a larger amount of heat can be transmitted to the material having high thermal conductivity 10.

Further, in the embodiment, a heat radiating section 11 serving as a setting table is provided in a lower part of the rotary machine. A part of the material having high thermal conductivity 10 is set in contact with the heat radiating section 11. In the rotary machine in the past shown in FIG. 1, a part of heat generated by the rotary machine is sent to a flange that fixes the rotary machine and the heat radiating section 11 such as the setting table and radiated through the frame 5 and the end bracket 6 made of a metal material. Therefore, in this embodiment, as in the embodiment in the past, a heat radiation path is formed from the stator 2 serving as the heat generating section and the bearing 4 to the heat radiating section 11 via the material having high thermal conductivity 10. Therefore, in the rotary machine in which the resin is applied to the stator coil 7 and the end bracket 6 is molded with the resin 9, an excessive temperature rise can be suppressed.

In this embodiment, irrespective of whether a position where the material having high thermal conductivity 10 is stuck is the setting table or the heat radiating section 11 that supports the rotary machine such as the flange, the effects of the present invention can be obtained because heat flux occurs as long as the position is a place where temperature is lower than rotary machine temperature. Further, the material having high thermal conductivity 10 is set in contact with a member that facilitates heat radiation such as a heat sink besides the heat radiating section 11 or a section corresponding to the heat radiating section 11, the effects of this embodiment can be further obtained.

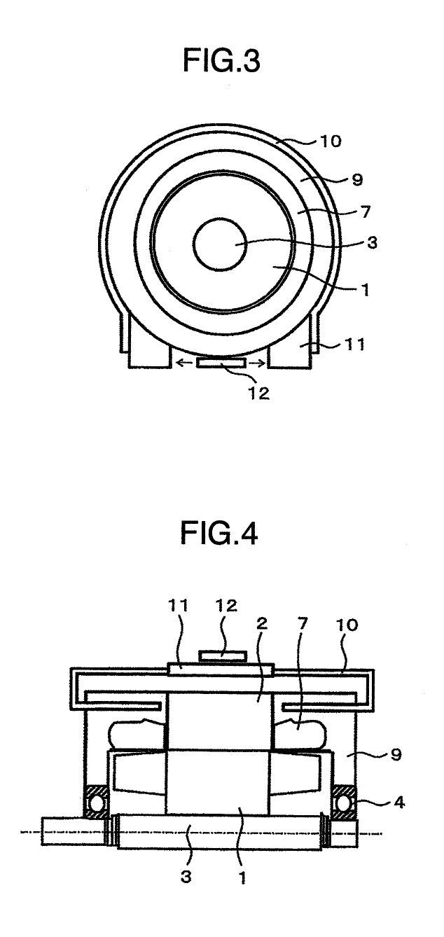

FIG. 3 is a sectional view of the rotary machine in this embodiment viewed from an axial direction end. In this embodiment, since a fan 12 for urging the heat radiating section to radiate heat is provided, the effects of this embodiment are further obtained. In this embodiment, heat generated by the rotary machine is actively and intensively led to the heat radiating section by the material having high thermal conductivity 10. Therefore, the entire rotary machine can be cooled by locally cooling the heat radiating section. An extremely small fan having low power is sufficient as the fan 12 for locally cooling the heat radiating section. Even the small fan 12 can obtain sufficient effects. Consequently, it is possible to obtain a temperature reducing effect by this embodiment while minimizing an increase in size due to attachment of a cooling element to the rotary machine molded with the resin 9.

The material having high thermal conductivity 10 in this embodiment may be a sheet-like material. The sheet-like material may be stuck or applied to the surface of the resin 9, the stator 2, and the bearing 4. When the material having high thermal conductivity 10 is the sheet-like material, an increase in the size of the rotary machine can be minimized by sticking a sheet. Therefore, it is possible to obtain a smaller rotary machine while suppressing a temperature rise of the rotary machine.

It is more desirable if the material having high thermal conductivity 10 is a sheet-like material (hereinafter, a graphite sheet). The graphite sheet is also present in a commodity having thermal conductivity in a sheet plane direction close to 1000 W/mK. The thermal conductivity is extremely high. The graphite sheet is relatively flexible and can be deformed according to a curved surface shape on the outside of the rotary machine. The graphite sheet is thin and light. The weight and size of a rotary machine main body can be further reduced than those of a rotary machine main body in which a metal plate or the like is used as the material having high thermal conductivity 10. Heat radiation properties can be substantially improved. Further, since the graphite sheet has a noise shield effect as well, an electromagnetic wave from the inside of the rotary machine can be blocked.

As bonding of the rotary machine and the graphite sheet, it is desirable to stick the graphite sheet to the surface of the resin at sufficient bonding pressure and it is desirable to bond the graphite sheet without a gap. If sufficient bonding is not obtained, it is desirable to stick the graphite sheet with an adhesive having low thermal resistance. As a result, generated heat from the rotary machine is efficiently transmitted to the graphite sheet and a large amount of heat can be transmitted to the material having high thermal conductivity 10.

It is desirable to appropriately select the thickness of the graphite sheet in use. As a characteristic of the graphite sheet, thermal conductivity in the surface direction of the sheet is particularly high. Therefore, a larger amount of heat can be transmitted by increasing the sheet thickness. However, since the flexibility is lost as the sheet thickness increases, for example, follow-up ability to a curved surface shape falls. This tends to be a cause of peeling.

Further, it is desirable to coat the graphite sheet with a material excellent in light resistance. In general, the graphite sheet has a characteristic that the graphite sheet is fragile as a material. Therefore, the fragility is supplemented by coating the graphite sheet with a material for protection. In order to secure adhesiveness with the rotary machine, it is desirable to coat only a surface opposite to the rotary machine bonding surface of the sheet. In general, rotary machines in general-purpose applications are classified into indoor rotary machines and outdoor rotary machines in terms of setting environments. Therefore, since a part of the rotary machines are continuously exposed to the sunlight, for example, if a resin section is exposed, aged deterioration of the resin worsens. Therefore, for example, the graphite sheet is coated with a light material excellent in light resistance such as acrylic resin to reinforce the fragility of the graphite sheet without hindering heat transportation of the graphite sheet. Further, the graphite sheet is stuck to the surface of the resin 9. Consequently, it is possible to suppress aged deterioration of the resin 9.

Further, when the material having high thermal conductivity 10 contains aluminum, silicon carbide, aluminum nitride, boron nitride, silver, copper, diamond-like carbon, or the like and is formed by a method such as chemical vapor deposition, sputtering, or spin coat, as in the case explained above, the effects in the present invention can be obtained.

FIG. 4 is a rotary machine sectional view according to another embodiment of the present invention. In this embodiment, in the embodiment of the present invention shown in FIG. 2, the material having high thermal conductivity 10 is inserted into the inside of the resin rather than onto the surface of the resin 9, the material is projected to the outside of the resin, and a projected portion is coupled to the heat radiating section 11 such as a heat sink that facilitates heat radiation.

As a result, a heat radiation path for radiating generated heat on the inside of the resin 9 to the outside via the material having high thermal conductivity 10 is formed. Therefore, as in the first embodiment, in a rotary machine in which the resin 9 is applied to the stator coil 7 and the end bracket 6 is molded with the resin 9, it is possible to suppress an excessive temperature rise.

Further, in this embodiment, it is more desirable if the material having high thermal conductivity 10 is a heat pipe.

The heat pipe is a closed-loop heat transfer element that makes use of latent heat of evaporation and condensation of liquid. It is possible to perform a large capacity of heat transport at a small temperature difference. It is desirable to provide a heat receiving section of the heat pipe in a position lower than a cooling section. When the liquid on the inside of the heat pipe is condensed by the cooling section and carried to the heat receiving section, it is possible to circulate the liquid to the heat receiving section earlier with the influence of the gravity and form an effective closed loop.

As a material of the heat pipe, it is desirable to use a material having high thermal conductivity such as copper. As a result, it is possible to increase heat transmitted through the pipe itself. Consequently, since a part of the heat pipe is projected to the outside of the resin 9, a heat radiation area is expanded by a projection area of the heat pipe and heat radiation to the outdoor air is improved.

Further, it is desirable to provide the fan 12 for facilitating heat radiation near the heat radiating section 11 such as the heat pipe. In this embodiment, as in the first embodiment, absorbed heat from the inside of the resin is collected in the heat radiating section 11, which expands the heat radiation area, and radiated. Therefore, as the fan 12 for locally cooling a portion where the absorbed heat is collected, a small fan having low power is sufficient. Even the small fan 12 can obtain a sufficient effect. Consequently, it is possible to obtain the temperature reducing effect by the present invention while minimizing an increase in the size due to attachment of a cooling element to the rotary machine molded with the resin 9.

FIG. 5 is a rotary machine sectional view according to still another embodiment of the present invention. In this embodiment, in the embodiment of the present invention shown in FIG. 2, a fin 13 for heat radiation is provided on a core of the stator 2.

In the rotary machine according to this embodiment, since the core of the stator 2 is exposed, the core of the stator 2 can be directly cooled. Therefore, a member for expanding a heat radiation area such as the fin 13 is provided on the exposed core of the stator 2. This makes it possible to easily improve heat radiation performance to the outdoor air. For reducing contact thermal resistance of the fin 13 and the core of the stator 2, it is desirable to eliminate a gap between the fin 13 and the core of the stator 2. When a gap is formed, it is desirable to fill the gap with heat radiation gel or the like.

As a material used for the fin 13, an aluminum alloy can be recommended because the aluminum alloy is inexpensive and has high thermal conductivity. It is also possible to improve heat radiation efficiency using other expensive materials when necessary.

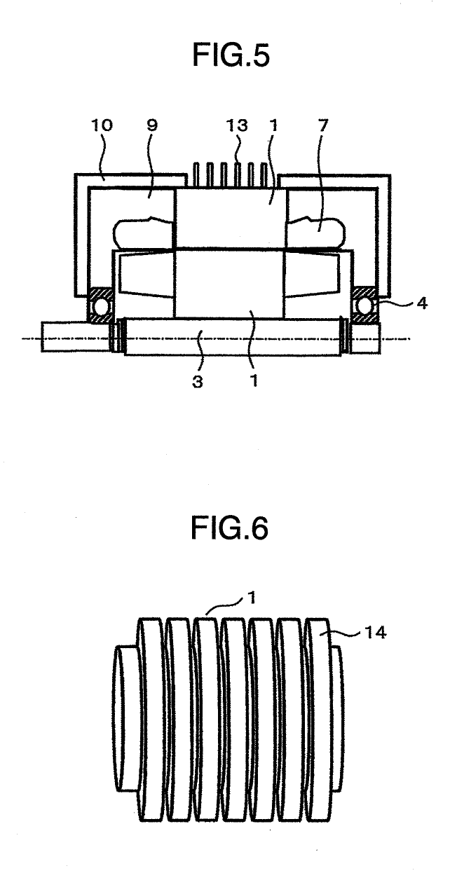

In general, the core of the stator 2 includes laminated steel plates 14. Therefore, as shown in FIG. 6, the fin 13 is formed by superimposing the laminated steel plates 14 having different diameters. As a result, it is possible to inexpensively form a fin that is advantageous thermally.

According to this embodiment, generated heat of the rotary machine is not only radiated from the heat radiating section 11 by the material having high thermal conductivity 10 but also directly radiated from the exposed stator 2 to the outdoor air. Therefore, a higher temperature reducing effect can be obtained.

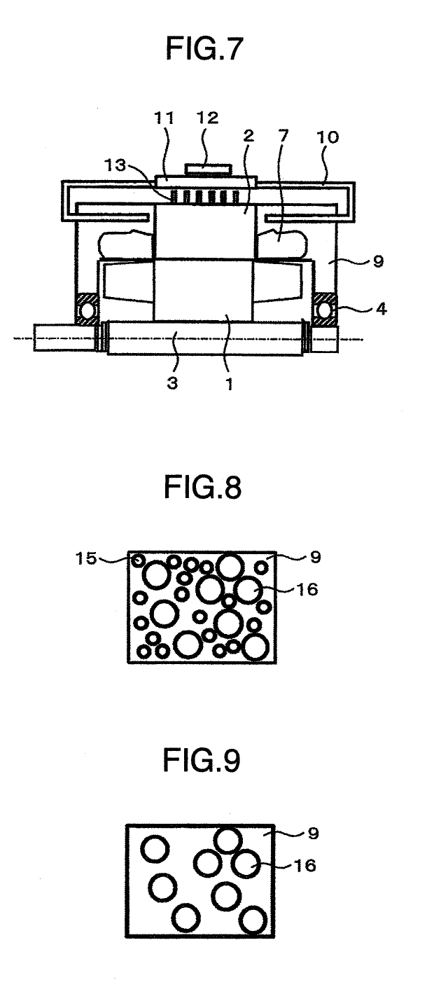

FIG. 7 is a rotary machine sectional view according to still another embodiment of the present invention. In this embodiment, in the embodiment of the present invention shown in FIG. 4, the fin 13 for heat radiation is provided on the core of the stator 2.

When the temperature of the fin 13 is higher than the highest temperature of the material having high thermal conductivity 10, it is desirable that the heat radiating section 11, with which the material having high thermal conductivity 10 is in contact on the outside of resin, and the fin 13 are not in contact with each other. When the temperature of the fin 13 is higher than the highest temperature of the material having high thermal conductivity 10, the temperature of the heat radiating section 11, with which the material having high thermal conductivity 10 is in contact on the outside of the resin, is equivalent to the fin temperature and heat flux of the material having high thermal conductivity 10 falls. Therefore, it is likely that the effects of the present invention cannot be sufficiently obtained. When heat flux from the rotary machine to the heat generating section occurs in the material having high thermal conductivity 10, this does not apply.

As a result, according to this embodiment, generated heat of the rotary machine is not only radiated from the heat radiating section 11 by the material having high thermal conductivity 10 but also directly radiated from the exposed stator 2 to the outdoor air. Therefore, a still higher temperature reducing effect can be obtained.

FIG. 8 is a sectional view of the inside of the resin applied to the rotary machine in the present invention. In this embodiment, a filler 15 having a particle outer diameter equal to or smaller than 100 nm is added to a sectional view of the inside of resin in the past shown in FIG. 9.

In general, as a filler added to reduce the coefficient of thermal expansion of the resin 9, a filler 16 having a particle outer diameter equal to or larger than 100 nm is mainly used because of mass productivity and easiness of addition to resin. On the other hand, when the particle outer diameter of the filler to be added decreases, a region of mutual action of the filler and the resin 9 increases. Therefore, even with addition of a small amount of the filler, a mechanical characteristic, a thermal characteristic, and an electric characteristic are improved. It is also reported that gas barrier properties, dimension stability, and the like are improved. In general, according to an increase in a power size of the rotary machine, an increase in strength of the resin 9 is requested because of an increase in the weight of the rotary machine. However, a small and light rotary machine molded with resin having larger power can be manufactured by using high-strength resin added with the filler 15 having the particle outer diameter equal to or smaller than 100 nm.

In order to verify the effects of the present invention, prototypes of the rotary machines according to the embodiments of the present invention were manufactured and measurement of size and weight and measurement of coil temperature during a rotary machine rated operation were performed.

### Example 1

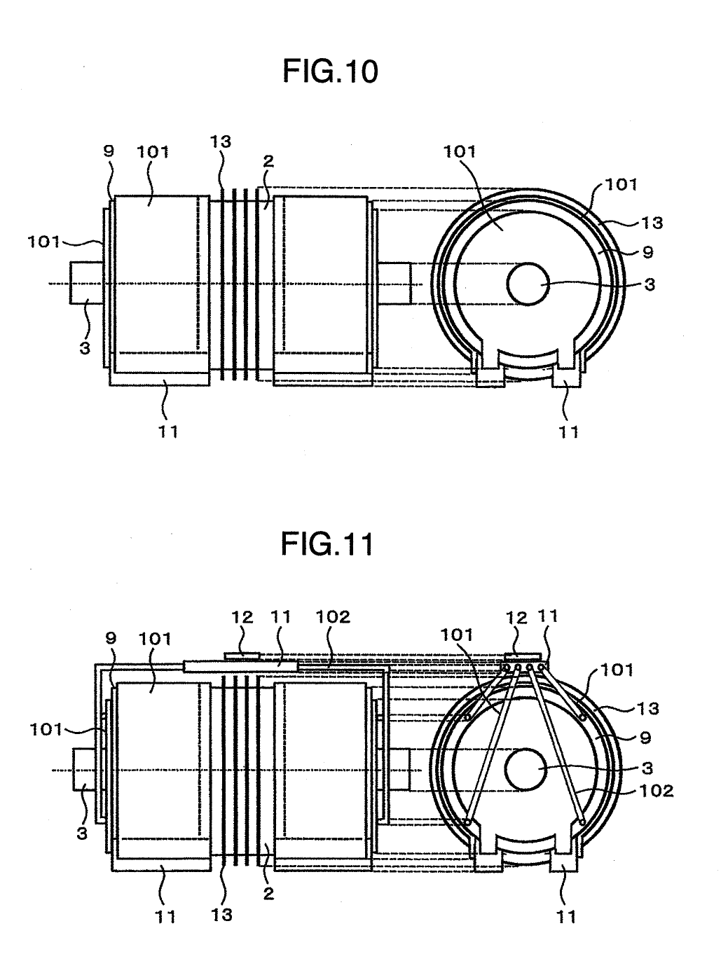

FIG. 10 is a sectional view of a prototype according to an example of the present invention (a half model).

In this example, in the rotary machine according to the embodiment in the past shown in FIG. 1, the frame 5 and the end bracket 6 are removed, the vicinity of the stator coil 7 is molded with the resin 9, and the end bracket is molded with the resin 9. In order to match the coefficient of thermal expansion of the resin 9 with the coefficient of thermal expansion of a material of the core of the stator 2 for the purpose of suppressing occurrence of a crack due to thermal stress, large amounts of silica and alumina fillers are added. A graphite sheet 101 provided with a coating material on a surface opposite to a resin bonding surface is stuck to the outer circumference and the axial direction end of the rotary machine. A part of the graphite sheet 101 is stuck to a part of the core of the stator 2, the bearing 4, and four heat radiating sections 11 serving as setting sections. Further, the fin 13 formed of aluminum is provided in the upper circumferential direction of the exposed core of the stator 2. Heat radiation gel is applied to an attaching place of the fin 13 for the purpose of reducing contact thermal resistance with the core of the stator 2.

### Example 2

FIG. 11 is a sectional view of a prototype according to another example of the present invention (a half model). In this example, in the rotary machine according to the example of the present invention shown in FIG. 10, four heat pipes 102 are inserted into the inside of the resin 9 from the axial direction end. A heat sink 11 and the fan 12 are attached to the other end of the heat pipes 102. A position where the heat sink 11 and the fan 12 are attached to the heat pipes 102 is set in an upper part of the rotary machine in order to provide a cooling section in a place higher than a heat absorbing section. The fin 13 formed of aluminum is provided in the upper circumference direction of the exposed core of the stator 2 as in the prototype according to the example 1. Heat radiation gel is applied to an attaching place of the fin 13 for the purpose of reducing contact thermal resistance with the core of the stator 2.

### Comparative Example 1

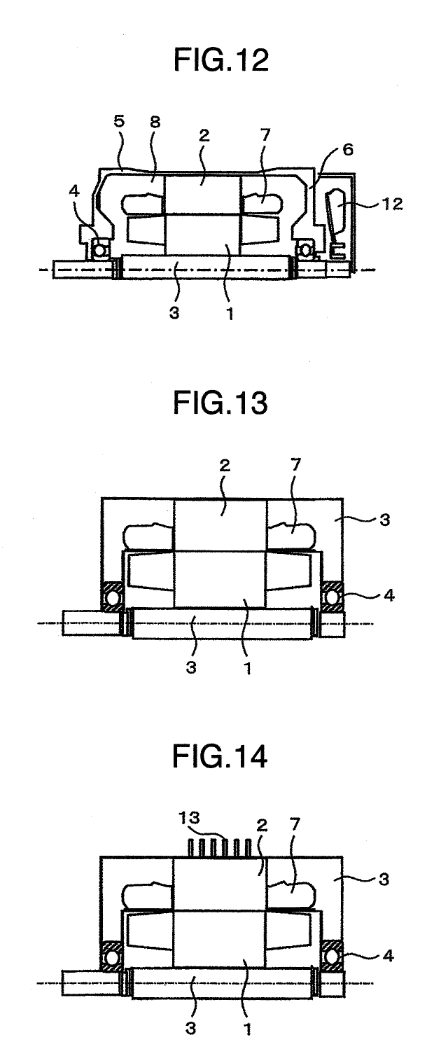

FIG. 12 is a rotary machine sectional view of a prototype according to an example in the past.

The rotor 1 and the stator 2, the rotating shaft 3 that is connected to the rotor 1 and transmits generated rotation force to the outside, and the bearing 4 that supports the rotating shaft 3 are provided on the inside of the housing including the frame 5 and the end bracket 6. Further, the space insulation 8 is provided to secure insulation between the stator coil 7 and the frame 5 or the end bracket 6. The fin 13 that rotates coaxially with the rotating shaft and is used for cooling the rotary machine is provided on the outside of the rotary machine.

### Comparative Example 2

FIG. 14 is a prototype sectional view for verifying the effects of the present invention.

In the prototype, in FIG. 13 of an example in the past, the frame 5 and the end bracket 6 are removed, the vicinity of the stator coil 7 is molded with the resin 9, and the end bracket 6 is molded with the resin 9.

### Comparative Example 3

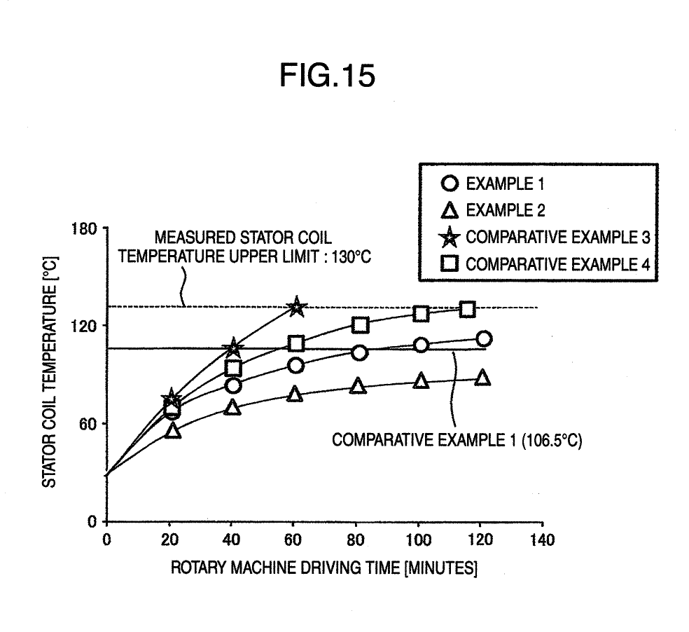

FIG. 15 is another prototype sectional view for verifying the effects of the present invention.

In the prototype, the fin 13 formed of aluminum used in the prototypes of the comparative example 1 and the comparative example 2 is provided on the outer circumference of the exposed core of the stator 2 of the prototype shown in FIG. 14. Similarly, heat radiation gel is applied to an attaching place of the fin 13 for the purpose of reducing contact thermal resistance with the core of the stator 2.

Actual measurement result 1: size

Actually-measured actual size ratios of the examples 1 and 2 and the comparative examples 1 and 2 to actually-measured actual size of the comparative example 1 are shown in Table 1.

TABLE 1

| Comparative | Comparative | Comparative | | |
|---|---|---|---|---|
| example 1 | example 2 | example 3 | Prototype 1 | Prototype 2 |
| 100% | 60.6% | 64.0% | 65.4% | 72.3% |

It is seen from Table 1 that the size of the comparative example 2 reduced by applying resin to the space insulation 8 and the size of the comparative example 3 in which the fin 13 is provided on the outer circumference of the core of the stator 2 decrease with respect to the comparative example 1 according to the embodiment in the past and a reduction in size is attained. The sizes of the examples 1 and 2 according to the present invention also decrease with respect to the comparative example 1 and a reduction in size is attained, although decrease ratios are smaller than those of the comparative examples 2 and 3.

Actual measurement result 2: weight

Actually-measured actual weight ratios of the examples 1 and 2 and the comparative examples 1 and 2 to actually-measured actual weight of the comparative example 1 are shown in Table 2.

TABLE 2

| Comparative | Comparative | Comparative | | |
|---|---|---|---|---|
| example 1 | example 2 | example 3 | Prototype 1 | Prototype 2 |
| 100% | 78.7% | 87.1% | 87.2% | 88.5% |

It is seen from Table 2 that the weight of the comparative example 2 reduced by applying resin to the space insulation 8 and the weight of the comparative example 3 in which the fin 13 is provided on the outer circumference of the core of the stator 2 decrease with respect to the comparative example 1 according to the embodiment in the past and a reduction in weight is attained. The weights of the examples 1 and 2 according to the present invention also decrease with respect to the comparative example 1 and a reduction in weight is attained, although decrease ratios are smaller than those of the comparative examples 2 and 3.

Actual measurement result 3: temperature of stator coil 7

Actually-measured temperatures of the stator coil 7 of the examples 1 and 2 and the comparative examples 2 and 3 are shown in FIG. 15. In the comparative example 1, the temperature of the stator coil 7 during continuous operation measured in the same measurement environment was acquired from catalog values. The measurement was performed at the room temperature (20° C.) and a temperature rise limit of the stator coil 7 was set to 130° C.

It is seen from FIG. 15 that the measured temperature of the stator coil 7 of the comparative example 2 reaches a measured temperature upper limit in about one hour after the start of measurement and still rises even after reaching the measured temperature upper limit. Consequently, it is seen that, when the vicinity of the stator coil 7 is molded with the resin 9 and the end bracket 6 is molded with the resin 9, there is no heat radiation path from the rotary machine and heat radiation is insufficient. Therefore, in the embodiment of the second comparative example 2, as shown in Tables 1 and 2, compared with the comparative example 1 according to the embodiment in the past, although the size and the weight are substantially suppressed, a rotary machine molded with resin that can perform long-time operation cannot be realized.

The temperature of the stator coil 7 of the comparative example 3 also reaches the measured temperature upper limit in about two hours after the start of measurement. Consequently, it is seen that, when the fin 13 is provided on the outer circumference of the exposed core of the stator 2 in the embodiment of the comparative example 2, although a temperature rise is suppressed compared with the case in which the fin 13 is not provided, a sufficient temperature reduction effect cannot be obtained. Therefore, in the embodiment of the comparative example 3, as in the comparative example 2, as shown in Tables 1 and 2, compared with the comparative example 1 according to the embodiment in the past, a rotary machine molded with resin that can perform long-time operation cannot be realized, although the size and the weight are substantially suppressed.

On the other hand, measured temperature of the stator coil 7 of the example 1 is still equal to or lower than the measured temperature upper limit after the elapse of about two hours after the start of measurement. In continuous operation after that, a large temperature rise is not expected. This is because of the temperature reduction effect according to the embodiment of the present invention, i.e., this is because, since the graphite sheet 101 is provided on the outer circumference of the rotary machine, whereby heat is efficiently transmitted to the heat radiating section 11, an excessive temperature rise is suppressed. As a result, the size and the weight with respect to the embodiment in the past shown in Tables 1 and 2, i.e., the comparative example 1 are substantially suppressed. Therefore, it is possible to realize a small and light rotary machine molded with resin that can perform long-time operation.

Measured temperature of the stator coil 7 of the example 2 further falls than that in the example 1. This is because of the temperature reduction effect according to the embodiment of the present invention, i.e., this is because the graphite sheet 101 is provided on the outer circumference of the rotary machine and, moreover, the heat pipe 102 is inserted into the inside of the resin 9 and a part of the heat pipe 102 projecting to the outside of the resin is connected to the heat sink having the fan 12, as a result, since heat is efficiently transmitted to the heat radiating section 11, an excessive temperature rise is suppressed. As a result, the size and the weight with respect to the embodiment in the past shown in Tables 1 and 2, i.e., the comparative example 1 are substantially suppressed. Therefore, even when generated heat of the rotary machine is large and the effect is insufficient in the example 1, it is possible to realize a small and light rotary machine molded with resin that can perform long-time operation.

It should be further understood by those skilled in the art that although the foregoing description has been made on embodiments of the invention, the invention is not limited thereto and various changes and modifications may be made without departing from the spirit of the invention and the scope of the appended claims.

1. A rotary machine comprising
a resin forming at least a part of the rotary machine,
a heat radiating member arranged at an outside with respect to the resin, and
at least one of a sheet including carbon-graphite and extending onto the resin and the heat radiating member so that the resin and the heat radiating member are thermally connected to each other through the sheet and a sheet including carbon-graphite and extending into the resin and onto the heat radiating member so that the resin and the heat radiating member are thermally connected to each other through the sheet.

2. A rotary machine comprising
a resin forming at least a part of the rotary machine,
a heat radiating member arranged at an outside with respect to the resin, and
at least one of a thermally conductive member including at least one of aluminum, silicon-carbide, aluminum-nitride, boron-nitride, silver, argentum, cupper and diamond-like-carbon and extending onto the resin and the heat radiating member so that the resin and the heat radiating member are thermally connected to each other through the thermally conductive member and a thermally conductive member including at least one of aluminum, silicon-carbide, aluminum-nitride, boron-nitride, silver, argentum, cupper and diamond-like-carbon and extending into the resin and onto the heat radiating member so that the resin and the heat radiating member are thermally connected to each other through the thermally conductive member.

3. The rotary machine according to claim 2, wherein the thermally conductive member extending into the resin and onto the heat radiating member is a heat pipe.

4. The rotary machine according to claim 2, further comprising at least one of a fin made of a thermally conductive material and contacting at least partially a stator of the rotary machine, and a fin made of a thermally conductive material and formed monolithically with the stator.

5. The rotary machine according to claim 4, wherein the thermally conductive material includes at least one of aluminum-alloy, silicon-carbide and cupper alloy.

6. The rotary machine according to claim 2, wherein the resin includes filler and one of a thermosetting resin and a thermoplastic resin, the thermosetting resin being one of epoxy-resin, phenol-resin, polyimide-resin and unsaturated-polyester-resin.

7. The rotary machine according to claim 6, wherein a maximum grain diameter of at least a part of the filler is not more than 100 nm.

8. The rotary machine according to claim 1, further comprising at least one of a fin made of a thermally conductive material and contacting at least partially a stator of the rotary machine, and a fin made of a thermally conductive material and formed monolithically with the stator.

9. The rotary machine according to claim 8, wherein the thermally conductive material includes at least one of aluminum-alloy, silicon-carbide and cupper alloy.

10. The rotary machine according to claim 1, wherein the resin includes filler and one of a thermosetting resin and a thermoplastic resin, the thermosetting resin being one of epoxy-resin, phenol-resin, polyimide-resin and unsaturated-polyester-resin.

11. The rotary machine according to claim 10, wherein a maximum grain diameter of at least a part of the filler is not more than 100 nm.

12. A rotary machine comprising, a stator, a stator coil arranged in the stator, a resin covering at least partially the stator and the stator coil so that the stator coil is electrically insulated by the resin, and a heat radiating member arranged at an outside with respect to the resin and thermally connected to a cooling member including a fin,
wherein the rotary machine further comprises at least one of a carbon-graphite member including carbon-graphite and extending onto the resin and the heat radiating member so that the resin and the heat radiating member are thermally connected to each other through the carbon-graphite member and a carbon-graphite member including carbon-graphite and extending into the resin and onto the heat radiating member so that the resin and the heat radiating member are thermally connected to each other through the carbon-graphite member, and a carbon-graphite coating including carbon-graphite and adhering to at least a part of outer peripheral surface of the stator.
